(19) United States
(12) Patent Application Publication
(10) Pub. No.: US 2005/0220106 A1
(43) Pub. Date: Oct. 6, 2005

(54) Inter-wireless interactions using user discovery for ad-hoc environments

(76) Inventors: Pierre Guillaume Raverdy, Paris (FR); Atsushi Shionozaki, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/815,401

(22) Filed: Mar. 31, 2004

(51) Int. Cl. H04L 12/56

(52) U.S. Cl. 370/392; 370/449

(57) ABSTRACT

An embodiment of the present invention is a technique to provide inter wireless network communication. A local node in a first network includes a frame module, an information module, and a communication module. The frame module processes a frame containing information regarding the first network. The information includes discovery information and network state information. The information is represented in a common description. The information module manages the information. The communication module manages communication between the local node and a remote node in a second network using the information.

### BACKGROUND

1. Field of the Invention

Embodiments of the invention relate to the field of wireless communication, and more specifically, to wireless interactions.

2. Description of Related Art

With wireless fidelity (WiFi) enabled mobile devices and widely available hotspots (i.e., public access points for wireless Internet access) or private access points in companies or at home, mobile users can easily connect to the Internet. Some of these access points accept any device, while some require the user to authenticate so that only registered devices/users can connect to the access point. While not common yet, mobile users and their WiFi enabled devices can also dynamically create a network without support of an infrastructure (i.e., ad-hoc network).

There is no standard mechanism for unrelated mobile users to dynamically create and join a common WiFi network and interact together, or for a mobile user to learn about the users and services available on a WiFi network without first joining this network.

In wireless networks, devices can send and receive packets with other devices that are in radio range. However, if two devices are not in the same WiFi network, their packets are filtered and these devices are not able to communicate. There is no existing mechanism in WiFi networks to allow a node to directly interact with nodes in other WiFi networks at the same location without causing termination or disruption to the current session.

### BRIEF DESCRIPTION OF THE DRAWINGS

The invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a node according to one embodiment of the invention.

FIG. 3A is a diagram illustrating a frame module according to one embodiment of the invention.

FIG. 3B is a diagram illustrating a hidden node problem according to one embodiment of the invention.

FIG. 3C is a diagram illustrating an effect of propagation type according to one embodiment of the invention.

FIG. 4A is a diagram illustrating an information module according to one embodiment of the invention.

FIG. 4B is a diagram illustrating a node selection according to one embodiment of the invention.

FIG. 5A is a diagram illustrating a communication module according to one embodiment of the invention.

FIG. 5B is a diagram illustrating a non-symmetric relationship of frames according to one embodiment of the invention.

FIG. 5C is a diagram illustrating a channel reallocation according to one embodiment of the invention.

FIG. 6 is a diagram illustrating frame formats according to one embodiment of the invention.

FIG. 7 is a diagram illustrating a computer system according to one embodiment of the invention.

### DESCRIPTION

An embodiment of the present invention is a technique to provide inter wireless network communication. A local node in a first network includes a frame module, an information module, and a communication module. The frame module processes a frame containing information regarding the first network. The information includes discovery information and network state information. The information is represented in a common description. The information module manages the information. The communication module manages communication between the local node and a remote node in a second network using the information.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

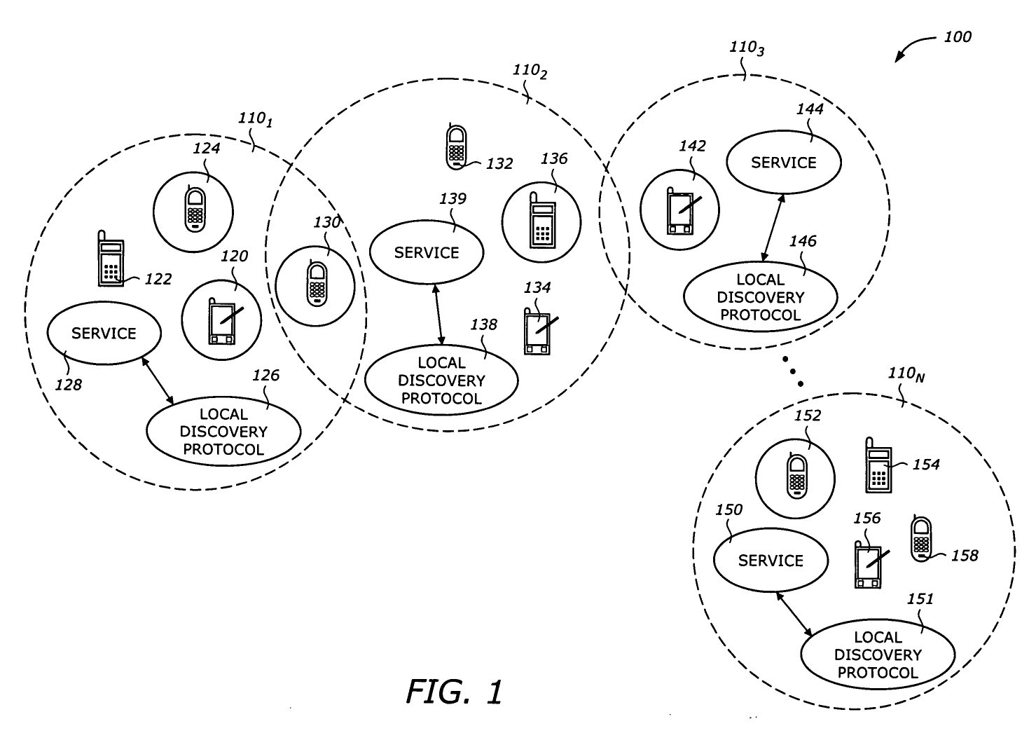

FIG. 1 is a diagram illustrating a system 100 in which one embodiment of the invention can be practiced. The system 100 includes N networks 110₁ to 110_{N}.

The N networks 110₁ to 110_{N} represent wireless networks or groups of mobile users having wireless devices. The wireless device may be a cell phone, a personal digital assistant (PDA), a notebook computer, or any other device that has wireless communication capabilities. In one embodiment, these networks are ad-hoc WiFi networks and the wireless devices have interface cards (e.g., WiFi cards). An ad-hoc network is a collection of wireless mobile hosts or devices forming a temporary network without any infrastructure. A WiFi network uses one of many available channels at different frequency ranges. These channels are on partially overlapping frequency ranges. The number of channels depends on country. For examples, in the United States, this number is 11. In Europe and Japan, this number is 12 and 14 respectively. Although it is possible for a device to receive a signal from another device located nearby but in a different network, its WiFi card filters the frames and only accepts incoming frames from devices in the same network that it has joined.

Each of the N networks 110₁ to 110_{N} may include one or more mobile users, one or more local discovery protocol, one or more services subscribed by the mobile users. For example, the network 110₁ has three wireless devices 120, 122, 124, and 130, a local discovery protocol 126, and a service 128. For simplicity, the network 110₁ is used for discussion.

The mobile users in the network 110₁ wish to interact with one another in the same WiFi network. To interact with others, the mobile users typically discover each other and learn about their respective services.

To interact with others in a different network, devices in a network may become special nodes. A special node in a network is a device that interacts with other special nodes in other networks to propagate information that enables inter-network communication. Not all devices in a network are special nodes. In FIG. 1, devices that are shown in circled are special nodes. For example, in the network 110₁, devices 120, 124, and 130 are special nodes. As will be described further later, the communication across different WiFi networks is referred to as inter-WiFi (IW) communication and is carried out by the special nodes.

The local service protocol 126 allows users in the same network to discover their environment, including users within the same network. Examples of the service protocol include Universal Plug and Play (UPnP™), Rendezvous, and zero configuration networking (zeroconf). The service 128 is any service that the users in the network have subscribed for. Examples of the service 128 include music sharing, game, etc.

One embodiment of the invention takes advantage of the fact that WiFi cards receive all the frames (e.g., 802.11 frames) if they are within the radio range of the sender, and that some 802.11 frames (i.e., management frames like beacons) are not filtered, to propagate information across different WiFi networks. A specific service on a IW node creates special 802.11 management frames that contain information about the WiFi network (e.g., channel usage, service or user discovery information) and has these frames be sent by the WiFi card of the device. When another IW node receives such a special frame, it extracts the content (e.g., discovery information) and forwards it to the appropriate applications or services. As WiFi channels do overlap, these special frames can be exchanged between nearby IW nodes on close channels. By allowing devices to forward and propagate the special frames across the networks, it then becomes possible for a device on channel 1 to communicate with another device on channel 11 if there are enough devices on intermediate channels in the vicinity.

IW communication is the mechanism that allows IW nodes on different WiFi networks at the same location to communicate with each other. The IW nodes (e.g., special nodes) are devices in a WiFi network that are participating in IW communication. IW information is the information exchanged between IW nodes for (1) discovering services, devices, and users on the different WiFi networks present at a location, and (2) evaluating the network usage and status of the different WiFi channels. These two types of information are IW discovery information and IW network state information.

IW management is the collaborative management of the WiFi channels by different WiFi networks at a location. The distribution of WiFi networks over the available channels at a location may not be efficient (e.g., many networks may be configured to use the channel 6). As different WiFi networks on the same or overlapping channels interfere, it may lead to poor WiFi network performance. To overcome these problems, it is necessary to be able to dynamically change the channel used by a WiFi network. Such changes are negotiated by the different WiFi networks in an area in order to avoid undesirable effects (e.g., all networks on channel 1 simultaneously moving to channel 11). With IW management, IW nodes use the collected IW network state information to negotiate a better distribution of the different networks. An IW node also takes into account that, if the channel allocation of WiFi networks at a location is too far apart (e.g., if nodes are on either channel 1 or 11), IW communication may not be possible or efficient.

IW frames are special 802.11 frames exchanged by IW nodes that contain IW information (e.g., discovery or network status) or messages related to IW management. An IW frame has a special format that contains IW information that is different from other 802.11 frames. In the following description, unless otherwise indicated, nodes, communication, information, management, and frames are IW nodes, IW communication, IW information, IW management, and IW frames.

In the case of discovery and network state information, an IW node can simply broadcast its information periodically. As there is no dependency in this information overtime, a best effort mechanism without acknowledgment can be used for the broadcast and propagation. Other IW nodes that receive this information will use the latest version available to report the discovery information and network status to the relevant applications or services. However, for IW management, a more complex protocol with acknowledgments is needed to ensure that multiple WiFi networks agree on certain types of information (e.g., WiFi channel number).

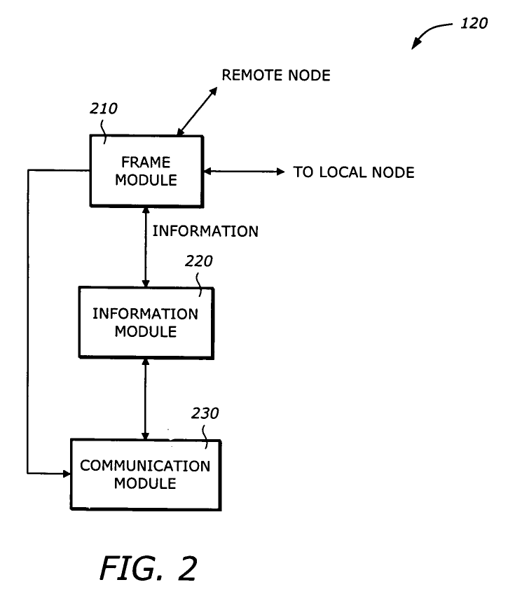

FIG. 2 is a diagram illustrating a node 120 according to one embodiment of the invention. The node 120 includes a frame module 210, an information module 220, and a communication module 230.

The frame module 210 processes an IW frame containing the IW information. It receives and transmits IW frames from remote nodes and local nodes. Remote nodes are nodes that are located in a different WiFi network and local nodes are nodes located in the same WiFi network. For example, in FIG. 1, with respect to node 120, nodes 124 and 130 are local nodes and nodes 136, 142, 152 are remote nodes. A remote node may actually be physically in a closer distance to a node than a local node.

The information module 220 manages IW information in a first IW network. The IW information includes discovery information and network state information. In one embodiment, IW discovery information is represented in a common description (e.g., language, format, representation).

The communication module 230 manages communication between the IW node and a remote node in a second IW network. The communication module 230 receives the IW information from the information module 220. It determines the relative location of the second IW network and decides whether the mobile device should change the channel.

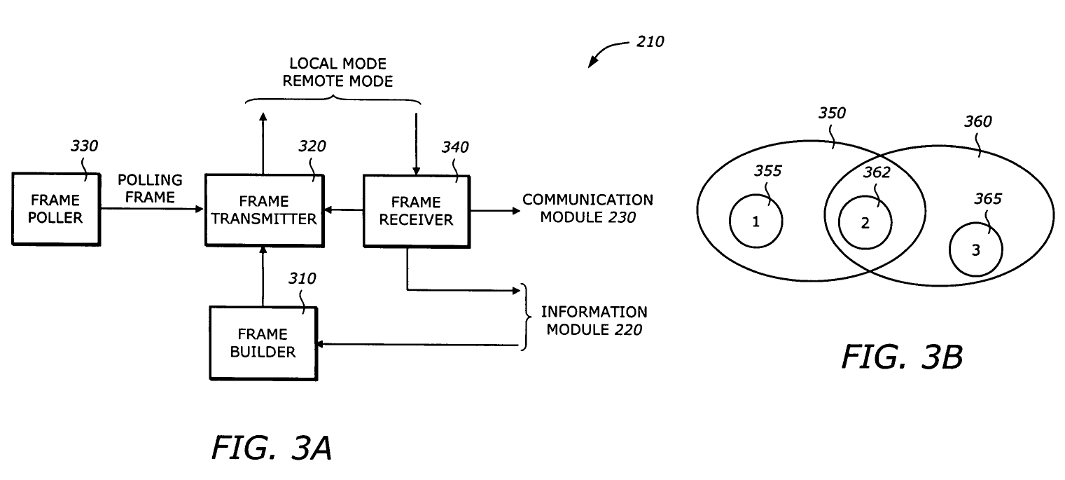

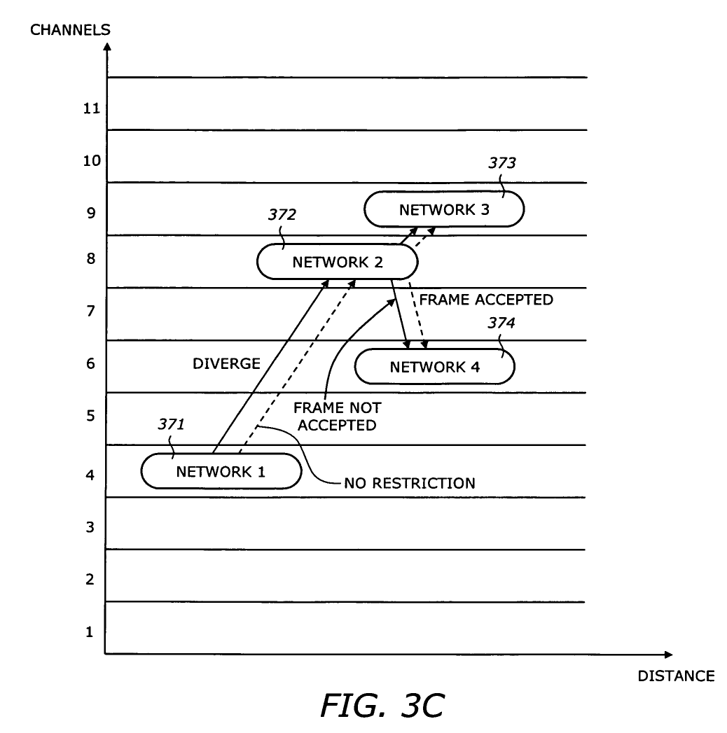

FIG. 3A is a diagram illustrating the frame module 210 according to one embodiment of the invention. The frame module 210 includes a frame builder 310, a frame transmitter 320, a frame poller 330, and a frame receiver 340.

The frame builder 310 builds the frame based on the IW information according to a predefined format. The IW information is collected by the information module 220 and passed to the frame builder 310. The format of the frame may be any convenient format that is used consistently by all IW nodes in the networks. The frame builder 310 also assigns a version number to the frame. The frame builder 310 also sets a maximum number of times the frame can be forwarded and specifies how the frame should be propagated by specifying a propagation type. Examples of propagation type include (1) no-restrictions: the frame can be accepted by any IW node, (2) diverge: the frame can only be accepted by IW nodes on channels that are away from the channel of the origin, as well as the channels of the previous IW nodes that propagated it, but can be the same as the channel of the last IW node to propagate it, and (3) strict-diverge: the frame can only be accepted by IW nodes on channels that are away from the channel of the origin, as well as the channels of the previous IW nodes that propagated it.

The frame transmitter 320 transmits the IW frame that can be received by any IW node in radio range (i.e., on the same or on a different WiFi network). A node in a network may be an active node or a passive node. An active node is a node in charge of deciding which information to propagate to other WiFi networks. The other IW nodes in the same WiFi network, if any, are called passive nodes. If the node 120 is an active node, the frame transmitter 320 sends the frame built by the frame builder 310 to other local IW nodes in the network so that all local IW nodes in the network broadcast the same frame.

The frame transmitter 320 also broadcasts the local IW information as contained in the frame to remote nodes in other networks as part of the IW communication. While the IW management protocol involves complex communication between IW nodes, the dissemination of IW information does not require coordination. There are in essence two inter-communication modes: a sender-initiated mode and a receiver-initiated mode. In the sender-initiated mode, the frame transmitter 320 of an active IW node sends its IW information contained in the frame periodically to announce the information to the remote nodes. In the receiver-initiated mode, the frame transmitter 320 sends a polling frame to request for IW information from a remote node. This may be alternatively be done when the node 120 receives another WiFi's network's beacon, considering this as an implicit polling.

The sender-initiated mode may cause unnecessary interference because the frame transmitter 320 periodically broadcasts IW frames even if there are no other WiFi networks in the vicinity, or if these WiFi networks do not support IW communication. In order to reduce such possible unwanted interference, WiFi networks that support IW communication may send a modified WiFi beacon (i.e., by adding a specific optional parameter after the mandatory information). The frame transmitter 320 may then only start broadcasting the IW frame when the node 120 detects another WiFi network that uses the modified beacon.

The receiver-initiated mode may also generate interference due to the use of extra polling frame. Since the discovery information and the network state information of nodes change over time, the node 120 has to periodically send polling frames in order to get updates resulting in a large number of polling frames. If the interval between polling frames is the same as the interval of the sender initiated mode, the receiver initiated mode will create more interferences. Therefore, it is preferable to use the sender-initiated mode.

The frame poller 330 prepares a polling frame to the frame transmitter 320 to send to the remote node to request for information of the remote node. The frame poller 330 may also be a part of the frame transmitter 320. The frame poller 330 is used when the receiver-initiated mode is used as discussed above.

The frame receiver 340 receives another frame from a local node in the same network or a remote frame from a remote node. The frame receiver 340 forwards the received frame using a forwarding or propagating policy. In order for IW information to reach all the WiFi networks in an area, IW frames need to be propagated by intermediate IW nodes. For example, two WiFi networks on channels 1 and 11 will not be able to exchange IW information without their IW frames being propagated by one or two IW nodes on intermediate channels. Propagating frames also helps to reach WiFi networks that are out of radio range but may soon be in range. Finally, an IW node that did not initially receive an IW frame due to network errors may still receive it when this frame is propagated by another IW node in the vicinity.

It is however important that not all IW nodes propagate all IW frames. In order to avoid an explosion of IW frames, the propagation scope of an IW frame is limited by introducing a hop count. This limit should be high enough to allow IW information to reach all the WiFi networks in the physical area that a mobile user may explore and on all the channels, but at the same time avoid IW information to reach WiFi networks which are too far away to be relevant, or to create too much interference. IW nodes should also not propagate an IW frame they already propagated. Finally, the IW node only propagates an IW frame if its channel is compatible with the propagation type defined. As an example of propagation type, the creator/sender of an IW frame may mandate that its IW frames are only propagated on the same channel.

Each IW frame contains a propagation list that provides information on the IW nodes that sent and forwarded the frame. The propagation list contains the network identifier (e.g., the BSSID) of each network that propagated the IW frame, as well as the channels of these WiFi networks and the MAC addresses of the IW nodes that propagated the IW frame. When propagating an IW frame, an IW node adds its MAC address, BSSID, and channel number of its WiFi network at the end of the propagation list, and then broadcasts the updated IW frame.

The frame receiver forwards the received remote IW frame to the communication module if the received remote frame is related to the IW management. If the received remote frame is related to information exchange and meets an acceptance condition, the frame receiver 340 forwards the received remote frame to the information module of the local node (e.g., the information module 220) or to another local node (e.g., nodes 124 or 130 in FIG. 1), and propagate it to other remote nodes (e.g., node 152 in FIG. 1).

The acceptance condition may be based on the IW information version number, a forwarding number, or propagation parameters. The version number, decided by the active IW node creating the IW frame, is used by IW nodes to detect duplicates (e.g., when an IW frame is propagated via different networks) or older IW information. IW nodes use this version number in conjunction with the network identifier. Each network has a unique identifier called the basic service set identifier (BSSID). This identifier may, however, change during the lifetime of the network, although not on a regular basis. The IW information received is managed according to the BSSID. When a network changes its BSSID, it is therefore considered to be a new network. Each time a frame is forwarded, the forwarding number is incremented. At the receiver, this forwarding number is compared with the maximum forwarding number. If the forwarding number is equal or greater than this maximum number, the frame is not forwarded. In one embodiment, the forwarding number is the hop count.

The propagation parameters may include the propagation list described above and a propagation type. Along with the propagation list, the propagation type indicates how the frame should be propagated with regards to the channel numbers as discussed in the frame builder 310

FIG. 3B is a diagram illustrating a hidden node problem according to one embodiment of the invention. FIG. 3B shows two networks 350 and 360 and three nodes 355, 362, and 365. The node 355 is the beacon sender for the network 350. Nodes 362 and 365 both belong to the network 360 and node 365 is the beacon sender for the network 360.

The range of the radio is shown as the periphery of the networks. The node 355 is in the range of the node 362, but not in the radio range of the node 365. If only the node 355 is The node 362 is in the range of the node 355 but it cannot receive any information regarding the network 350 until node 355 comes in the range of the beacon sender of the network 360, which is the node 365. Such an instance, when groups are potentially overlapping but cannot receive beacons or important information regarding the other group, is referred to as the hidden node problem. A solution may be to have each IW node in the network 360 periodically send an alternate beacon, which would require more extensions.

FIG. 3C is a diagram illustrating an effect of propagation type according to one embodiment of the invention. There are 4 networks: network 1 371, network 2 372, network 3 373 and network 4 374.

The networks 371, 372, 373, and 374 occupy the channels 4, 8, 9, and 6, respectively. If an IW node in the network 371 sends a frame having a no-restriction propagation type to the network 372, the IW node in the network 372 forwards this frame to both networks 373 and 374. Since this frame has a no-restriction propagation type and assumes that the maximum forwarding number has not been exceeded, it will be accepted by both networks 373 and 374.

If the IW node in the network 371 sends a frame having a diverge or strict diverge propagation type to the network, the IW node in the network 372 forwards to both networks 373 and 374. The IW node in the network 374 will not accept this frame because it is not located in a channel that is further from the channel of the originating network, which is network 371. The IW node in the network 373 will accept this IW frame because it is located in a channel that is further from the channel of network 371.

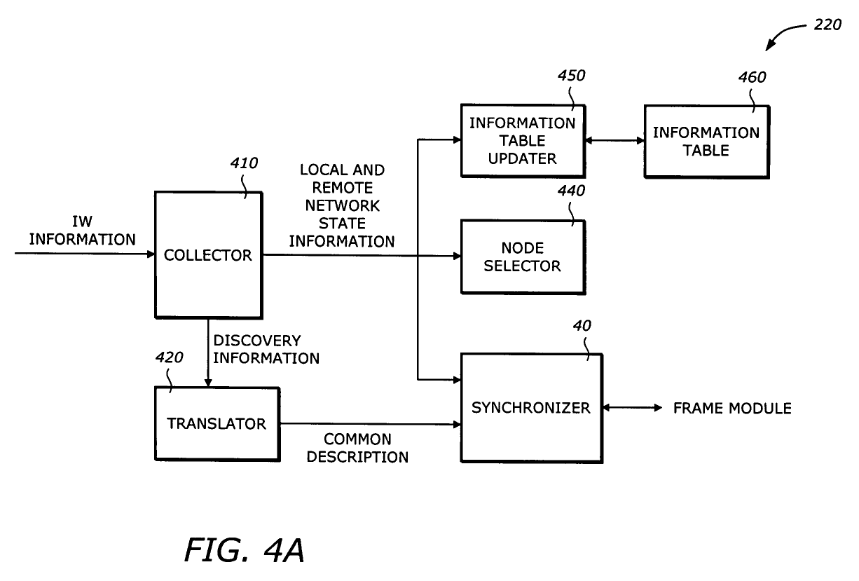

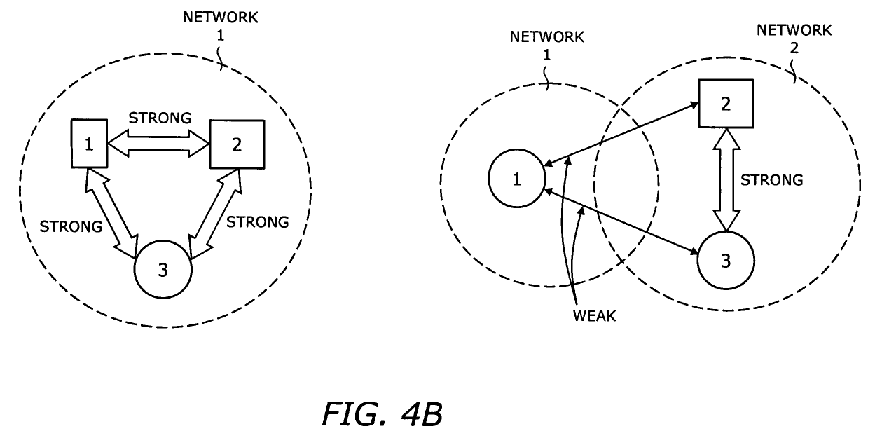

FIG. 4A is a diagram illustrating the information module 220 according to one embodiment of the invention. The information module 220 includes a collector 410, a translator 420, a synchronizer 430, a node selector 440, an information table updater 450, and an information table 460.

The collector 410 collects the IW information. The IW information includes the discovery information and the network state information. The network state information covers information collected by IW nodes from the clients of their WiFi network and includes: (1) WiFi network configuration such as ESSID, channel, rate, encryption., etc., (2) WiFi network status such as signal strength of the different clients, bandwidth use, interference/noise observed, (3) WiFi network history such as creation time or changes in client membership.

Collecting information from multiple clients within a WiFi network allows to better estimate the interference and bandwidth available for this network in this area. Contrary to service discovery information, there is currently no standard related to the collection of this information within a WiFi network. One embodiment of the invention provides such a mechanism. The network state information is collected from the different clients in the WiFi network. There is no standard application programming interface (API) to extract this information and it is currently highly driver and operating system (OS) dependent. In one embodiment using Linux implementation, network status information is provided by the hotstap driver using the Wireless Extensions. Each client in the WiFi network can periodically provide its information. In order to support any change in the WiFi network membership or in the set of IW nodes, this information is multicast on a well-known IP multicast group.

Each implementation of a discovery protocol usually provides an API that allows applications to retrieve discovery information. This information is available in a centralized registry. It may be distributed among the different members of the network. The IW information module uses such API to collect this discovery information. If multiple discovery protocols are supported within the WiFi network, the IW information module must register with all discovery protocols, collect their information, and may discard duplicates (e.g., this may happen if a service registers with both UPnP and Rendezvous).

The exchange of IW network state information between IW nodes on different WiFi networks allows to determine how many networks and clients are in their vicinity, how these clients use their respective WiFi channels and how much interference they experience.

Discovery protocols used in a WiFi network allow any device to discover other devices in the same network, their users and their services. Examples of discovery protocols include UPnP's SSDP or Apple's Rendezvous. The information collected by the discovery protocols allows applications to (1) learn about their environment and (2) start interactions with other applications or services. Depending on the discovery protocols used, the information collected may be different. For example, the service registry may be fully distributed on each device (e.g., Rendezvous), or it may be centralized on a particular device within the local network (e.g., Java's RMI). There is no mechanism that enables applications on different WiFi networks to interact. Therefore, IW nodes do not need to advertise all of their discovery information to other WiFi networks. The subset to advertise depends on (1) the discovery protocol, (2) the bandwidth available for IW communication, and (3) privacy and security issues. As an example, a subset may just contain the name and type of the services available in the WiFi network but not the IP addresses and ports to access them.

Applications in each WiFi network will use the discovery protocols that they support to discover devices, services, and users within their network. However, if services or applications want to learn about devices, services, or users in the vicinity that are not within their network, they communicate with one of the IW nodes to retrieve IW discovery information. The IW discovery information cannot be available in the various formats defined by the different discovery protocols. Therefore, a common description of discovery information is needed.

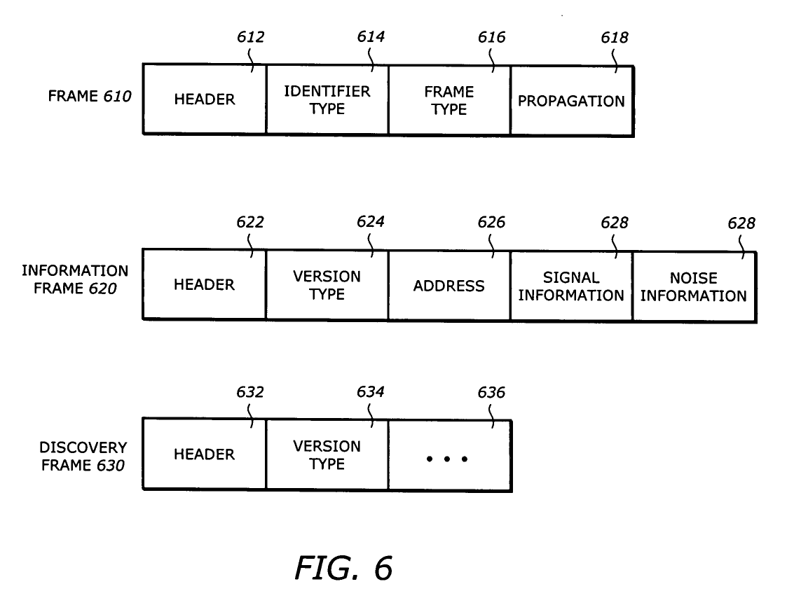

The translator 420 translates the protocol-specific information into this common description. The common description includes information on (1) devices: maker, configuration, addresses . . . (e.g., networked iPod from Apple with a MAC address XX:XX:XX:XX:XX:XX:XX:XX), (2) Services: type, name, port number . . . (e.g., a MP3 sharing service called NetMusicMatch on port 8895), and (3) Users: name, nickname, email address . . . (e.g., mike doe aka klee321 with email klee321@newnet.com). The common description may have any suitable format that is consistent across all the participating IW nodes in all networks. Examples of these formats are shown in FIG. 6.

The node synchronizer 430 synchronizes the collected local discovery information between the different IW nodes in the first network. As the different IW nodes in one local network collect local discovery information independently, they may have discrepancies in their views of the network (e.g., they may query the discovery protocol at slightly different times, or may not receive some of the messages. The node synchronizer 430 synchronizes the collected information before sending it to the IW frame module as they need to send the same information with an identical version number. While it is possible to synchronize all the IW nodes in the WiFi network so that each builds the IW information to send based on the same network status information and the same discovery information, such synchronization is complex to implement.

The node selector 440 determines if the node participates in the communication based on the network state information of the node and other network state information from another node in the first network. As there is no specific requirement for the active node, a simple election protocol can be used to dynamically decide which node should be active. While all nodes collect the network status and discovery information independently, only the active node assigns a version number to its information and builds a frame. The active node then sends the newly build IW frame to the passive nodes so that all IW nodes in the WiFi network broadcast the same IW frame. If the active node disappears, a new active node is elected.

One or more devices in a WiFi network can take part in the communication scheme. If only one device is sending IW messages, less interference will be generated. Managing the IW information is also easier as there is no need for synchronization when collecting internal discovery and network state information or when receiving/propagating IW information from other networks. Alternatively, when multiple devices in a WiFi network participate in the IW communication scheme, the area covered may be expanded, leading to a better knowledge of the networks in the vicinity. Also, the redundancy limits the effects of frame loss as interference affects devices independently.

When exchanging network state information between themselves, devices in a WiFi network can evaluate if they are close to each other or not. Based on this information, devices can decide if is necessary for one or more devices to advertise IW information, and which device(s) will advertise this information. An example of the node selection is given in FIG. 4B.

The information table updater 450 update the entries in the information table 460. The information table 460 stores entries regarding information extracted from a received remote frame. If an IW frame has been accepted, it is transmitted to the IW information module that checks if it already has an entry for this WiFi network in the information table 460. If not, the information table updater 450 creates an entry for it and initializes it with the information received. If it already has an entry, the information table updater 450 compares the version number of the received information with the IW information already received for this WiFi network. If it already received the IW information with the same version number, the information table updater 450 discards the message. If not, the information table updater 450 enters the information received into the information table 460.

As more and more frames are collected, the node will discover more and more WiFi networks. In the meantime, some of the discovered WiFi networks will move out of the radio range or cease to exist. The node will then stop receiving updates for these WiFi networks. Based on the update rate as provided in the IW frame header, the node can decide when too many updates have been missed and decide to purge the relevant IW information. The node then notifies the other nodes on its WiFi network.

Each network is identified by its BSSID. However, the same WiFi network may change its BSSID over time. A BSSID change may be triggered when a client leaves the WiFi network, when a new client joins it, or when the WiFi network splits into multiple WiFi networks because of users moving away of each others. In this last case, multiple networks with the same WiFi configuration will exist close to each other. They will however have different BSSID (except for one that may retain the previous BSSID). In these cases, the information module 222 (FIG. 2) will maintain multiple entries for the same WiFi network (old and new BSSID). After some time, the old entry will be considered obsolete and deleted. However, until this information is deleted, it may alter the network usage estimation (e.g., overestimating the usage of a channel by adding the new and the old entries) and lead to unnecessary migration of WiFi networks to different channels. A WiFi network may also report IW information while subject to a short-lived period of interference or unusual traffic pattern. It is therefore necessary to collect some data overtime before IW management is initiated.

FIG. 4B is a diagram illustrating examples for node selection according to one embodiment of the invention. In both case, one network has three clients (nodes 1, 2 and 3). The dotted circles represent the radio coverage for the different clients.

In the first example, the three nodes 1, 2, and 3 are close to one another. They all experience a strong signal strength from the other devices. Therefore, they can assume that they are close to each other and cover the same area. In that case, only one device may be selected as IW node as they will cover the same area and experience the same interference. The election may use any appropriate election policy. In one embodiment, the election policy is arbitrary. For example, node 3 is selected.

In the second example, node 1 experiences a weak signal strength from the rest of the clients, meaning that it is far away from the rest of the devices and that it covers a different area. Node 1 can decide to also become an IW node as it may receive frames from other WiFi networks in its vicinity that are not in range of the other devices. Node 3 may decide to be an IW node for the rest of the clients (Node 2 and Node 3).

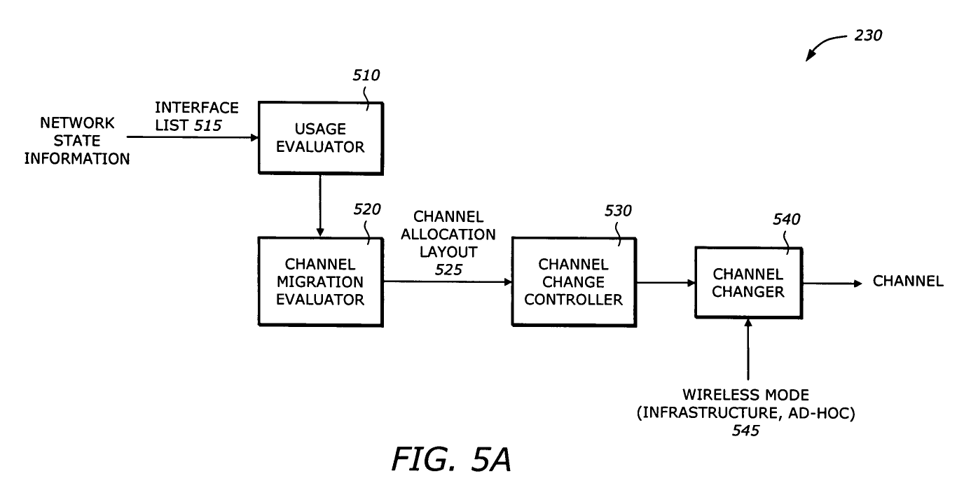

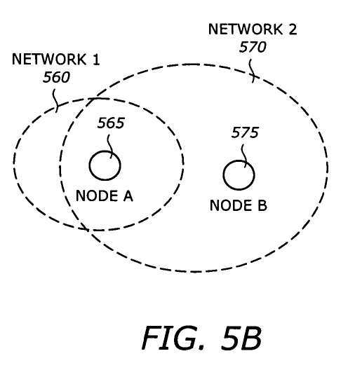

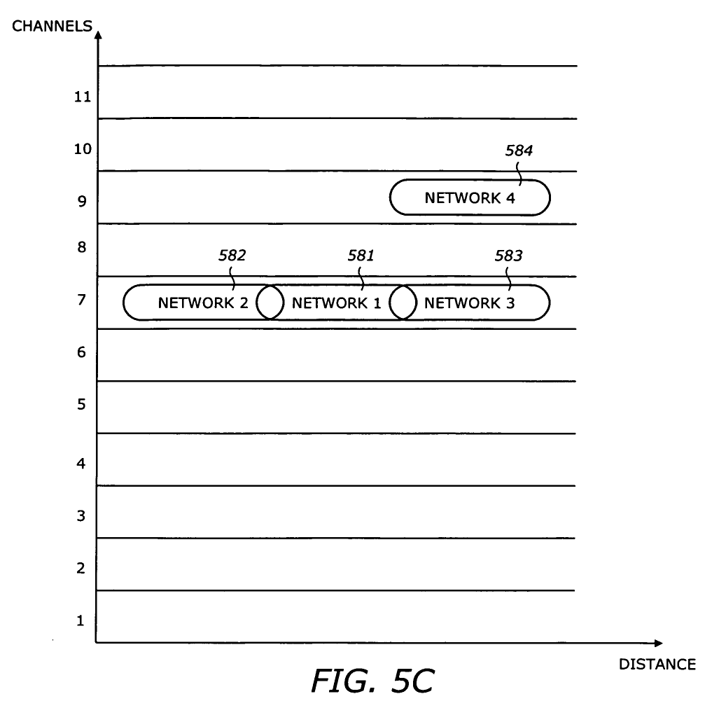

FIG. 5A is a diagram illustrating the communication module 230 according to one embodiment of the invention. The communication module 230 includes a usage evaluator 510, a channel migration evaluator 520, a channel change controller 530, and a channel changer 540.

The usage evaluator 510 evaluates network usage to determine relative location of the second network based on an interference list from the network state information. The communication module 230 first communicates with the information module 220 and collects the network status information from the nearby WiFi networks (e.g., number of WiFi networks per channel, bandwidth usage within each WiFi networks, frame loss ratio). However, this information is not sufficient as the information collected may correspond to WiFi networks that are not in radio range (e.g., that are too far away geographically to affect WiFi performance). Also, WiFi networks that do not support IW communication may exist. For these WiFi networks, network status information will not be available.

In order to evaluate the WiFi usage at a location, it is necessary to first determine where other WiFi networks are located to see if they will interfere. This is because IW information of a WiFi network may propagate over large distances, depending on the propagation type, the number of WiFi networks in the area, and the transmission power of the IW nodes. The propagation hop count thus is not a sufficient measure to determine if a particular network is nearby and in range enough to cause interference.

Each IW node advertises, as part of its IW network status information, a list of WiFi networks from which (1) it received a beacon, or (2) it directly received an IW frame (i.e., propagation hop equals 1). This list is called the interference list. If an IW node directly receives a beacon or IW frame of another WiFi network, it will also receive the 802.11 data frames of this network, which would be the cause of possible interference. It is important to note that this relation (receiving another WiFi network's IW frames or 802.11 beacon) (1) is not symmetric as shown in FIG. 5B, and (2) is not transitive (i.e., if WiFi 1 interferes with WiFi 2, and WiFi 2 interferes with WiFi 3, WiFi 1 and WiFi 3 do not necessarily have to interfere with each other.

By comparing the interference lists, active IW nodes are able to determine the relative location of the WiFi networks nearby, which WiFi networks overlap, and which channels at a location are over- or under-used. Interference lists do not provide a precise location of the WiFi networks at a location, or a distance between them. They only indicate how networks interfere. By using a history of the interference lists, it however becomes possible to detect moving networks, and to predict how a moving network will impact its future location.

The channel migration evaluator 520 evaluates a channel allocation layout. In order to determine the best layout for the different WiFi networks at a location, IW nodes need to predict how the different WiFi networks will communicate. Estimating bandwidth requirements of applications in a fixed wired network is already a complex task. Such a task becomes even more complex when the communication medium is shared by unrelated, mobile users creating multiple networks. A mechanism that precisely determines bandwidth requirements for each of the different WiFi networks is not necessary. Network usage heuristics are sufficient to approximate future network conditions.

Different WiFi networks at a location and on the same or adjacent channels interfere when their nodes communicate. The currently recommended layout (e.g., using channels 1, 6, 11) tries to spread WiFi networks on channels that do not interfere. Such layout is optimum when the density of WiFi networks is low. As more mobile devices become WiFi-enabled, and this density increases, channel allocation layouts need to be evaluated. A mechanism for determining how two WiFi networks at a location interfere depending on their channel distance becomes necessary. Experiments may be conducted to evaluate such relationships. Guidelines for such experiments are provided later. Based on this relationship, the channel migration evaluator 520 in each active IW node evaluates alternate layouts where the WiFi network of the IW node is on a different channel. If the improvement in terms of interference for an alternate layout surpasses a given threshold, the IW node selects this layout and prepares for a channel change. A key point is that this layout should keep IW communication “alive”. The potential channel should therefore overlap with the channel of another WiFi network supporting IW communications in the area. An example is shown in FIG. 5C.

Alternate layouts that require multiple synchronized channel changes of different WiFi networks are not evaluated. The channel migration evaluator 520 only evaluates an alternate channel for the network its node is part of. Such alternate layouts with only one channel change may not be optimal but limits the procedure so that only an active IW node can change its own WiFi network's channel. Furthermore, as different WiFi networks may interfere with different sets of WiFi networks, the optimal layout for different WiFi networks may be different. Such evaluations may be too complex but are possible.

The channel change controller 530 controls the channel change for the network. Although active IW nodes evaluate alternate layouts independently, they still need to cooperate in order to limit the rate of channel changes at a location.

When an active IW node decides to switch to another channel, it first propagates a special IW frame describing the change. This frame contains the identifier of the WiFi network and also the current and target channels. This IW frame is propagated similarly to IW information frames. If no IW management frame from another WiFi network describing a channel change is received within a given period of time, the IW node performs the channel change. If such an IW management frame is received, a random delay is computed before the IW node tries again to change its channel (e.g., a collision has occurred and the two nodes back off randomly so that one will be able to change its layout). After the channel change is performed, another IW management frame is sent confirming the change. When an active IW node receives such confirmation frame, it waits a specific period of time before evaluating alternate layouts for itself.

The channel changer 540 changes the channel of the node according to a wireless mode used by the node. The wireless mode includes an infrastructure mode and an ad-hoc mode.

Performing a channel change depends on the WiFi mode used. In infrastructure mode, the access point can change the channel of the WiFi network directly. The clients of this WiFi network will automatically change to the new channel. In ad-hoc mode, it is important that all clients simultaneously switch to the new channel. If only some of the WiFi network's clients switch to the new channel, clients may synchronize on the new channel, or may synchronize on the old channel. The timing of the switch at the firmware level decides of the outcome.

FIG. 5B is a diagram illustrating a non-symmetric relationship of frames according to one embodiment of the invention. This relationship illustrates one property of the interference as discussed in the usage evaluator 510 above.

There are two networks: network 1 560 and network 2 570. Network 560 has node A 565 and network 570 has node B 575. The node A 565 receives the IW frames from the node B 575 but the IW frames from node A 565 are not received by the node B 575.

FIG. 5C is a diagram illustrating a channel reallocation according to one embodiment of the invention. There are four networks 581, 582, 583, and 584.

The three networks 581, 582, and 583 are on channel 7 and the network 584 is on channel 9. The IW node in the network 581 may decide to relocate to channel 11 but not on channel 1 as the network 584 is on channel 9 so that IW communication is still active.

FIG. 6 is a diagram illustrating frame formats according to one embodiment of the invention. There are three types of frame: a frame 610, an information frame 620, and a discovery frame 630.

When an 802.11 frame is sent by a device, it is received by other devices in radio range that are on the same or on adjacent channels. However, due to interference/collision or poor network conditions, a device in range may not receive the frame. Frame loss between WiFi networks on adjacent channels can be high when there is lot of activity on a channel. A best effort approach for the IW communication mechanism is preferred. The WiFi networks will try to build knowledge of their environments from the information (e.g., frames) that they receive. It is also preferable to have the content of IW messages fit in a single frame.

If the data that needs to be sent to other networks does not fit within a single frame (e.g., the list of services available in a network is too long), the data should be organized into independent subsets and transmitted on multiple frames. Each frame should be self-sufficient (e.g., the frame contains all the information needed to process its content), so that receiving devices can decode it, without the need for other frames, and build at least partial state of a certain network. As an example, the type of discovery protocol used, the total number of services, users, and devices can fit in a frame, and the detailed list of services may then be sent in additional frames. However, IW communication introduces interference and it is essential that the impact on normal intra-network communication is minimal. By sending the initial summary frame more often than the complimentary frames, devices on other WiFi networks will receive enough information (albeit partial) to provide feedback to the user and applications running on the device.

In IW communication, information can be propagated to nearby WiFi networks and can reach WiFi networks that are either out of radio range or on non-overlapping channels via intermediary IW nodes. However, it is important to limit the propagation of IW frames, in order to reduce interference. Furthermore, the IW information of a WiFi network may not be relevant to another WiFi network a few hundreds meters away. An IW node does not propagate the same information multiple times, or does not propagate an IW frame that has already been propagated by another IW node within the same WiFi network.

As discussed above, each IW node that propagates an IW frame appends propagation information to it. This information will allow any future receiving IW nodes to determine if it should continue to propagate this frame. The size of the propagation information is proportional to the number of hops allowed for the IW frame. When creating an IW frame, the IW node should therefore reserve enough space at the end of the frame for this extra information to be added.

Identifiers: The following unique identifiers are used for IW communication:
(1) MAC address: is unique to each host (network hardware), (2) Basic Service Set Identifier (BSSID): this identifier is unique to each WiFi network but may change in the case of ad-hoc networks (e.g., when the reference host for the network's beacon changes). BSSID is a 48 bit network identifier as defined by the IEEE 802.11 standards. The BSSID and the MAC address are the two identifiers that are the most convenient for collecting and organizing the IW information.

The frame structure 610 includes a header 612, an identifier type 614, a frame type 616, and propagation parameters 618.

The header 612 may include the following information (1) The frame starts with an identifier type (e.g., 4 bits), an identifier length (e.g., 6 bits) and then the identifier of the originator, (2) Then there is a common header that contains the type of the frame (e.g., 4 bits), the maximum propagation (e.g., 4 bits), the type of propagation (e.g., 4 bits), and the current propagation count (e.g., 4 bits), (3) Following that generic header, the specific header for each type of frame and the actual data may be shown, (4) Finally, a list of BSSID (48 bits) and channel (6 bits) number that represents the propagation list may be shown.

The identifier type 614 is limited to 256 bits. Only the following type is defined: 0: the identifier is composed of the node MAC address, occupying 48 bits, the WiFi network BSSID occupying 48 bits, and the WiFi network channel occupying 6 bits. The frame type 616 specifies one of the following types: (1) 0: network information, (2) 1: network management, (3) 2: discovery information. Propagation parameters 618 may include a current propagation count and a propagation type. The current propagation count starts at zero and is incremented by each propagating node (not the originator). When the current propagation count equals the maximum propagation count, the propagation stops. The following propagation types may be used (1) 0: no restriction on propagation, (2) 1: only WiFi networks on the same channel as the originator should propagate, (3) 2: only WiFi networks on a different channel as the originator should propagate, (4) 3: only WiFi networks on an ascending or descending channel path should propagate (e.g., starting from channel 8, and after a chain of propagation of 6 and 4, only nodes on channel 4, 3, 2, or 1 should propagate the frame, and after a chain of propagation of 9 and 10, only nodes on channel 10 or 11 should propagate the frame), (5) 4: only WiFi networks on a strict ascending or descending channel path should propagate (e.g., starting from channel 8, and after a chain of propagation of 6 and 4, only nodes on channel 3, 2, or 1 should propagate the frame, and after a chain of propagation of 9 and 10, only nodes on channel 11 should propagate the frame).

The information frame 620 includes a header 622, a version number 624, an address 626, a signal information 628, and a noise information 629. The header 622 consists of the format of the statistics (e.g., 8 bits) followed by the version number 624 (e.g., 16 bits) and the number of individual statistics (e.g., 8 bits). One type of network information frame may be defined: 0: Each stat contains 3 elements, first the MAC address 626 of the stat node, then the signal and noise information 628 and 629 from the 802.11 device. Each IW node in the WiFi network collects this information within the network. All IW nodes on the same WiFi network sends a synchronized version, including content and version number.

Network Management Frame: Network management frames are part of protocols for helping unrelated WiFi networks to cooperate in order to minimize interference while still allowing IW communication.

The discovery frame 630 includes a header 632 and a version number 634. The rest of the information is dependent of the discovery protocol used and the filtering protocol used.

As mentioned previously, while the network information may not require more than a frame, the discovery information may not fit into a single frame. In such a case, the information needs to be split in self-sufficient parts and sent in multiple frames. A receiver will construct the information back from the received frames. If some frames are missing, complete information will not be available (e.g., only device and service information but not user) or older versions of the missing frames may be used. A tree-based hierarchy for the discovery related frames may be used. The root describes the discovery protocol used and the tree layout. The root's immediate child contains a summary of each discovery protocol's elements (e.g., users, devices, services, sessions, . . . ). Each of this child will then have a set of child listing the specific items (e.g., user1, user2 . . . . userN). When receiving a discovery frame, a device creates or completes the tree associated to it. When the user or an application on the device request information about the other networks, either the most recent complete version of the discovery information is used, or one is built from the most recent versions.

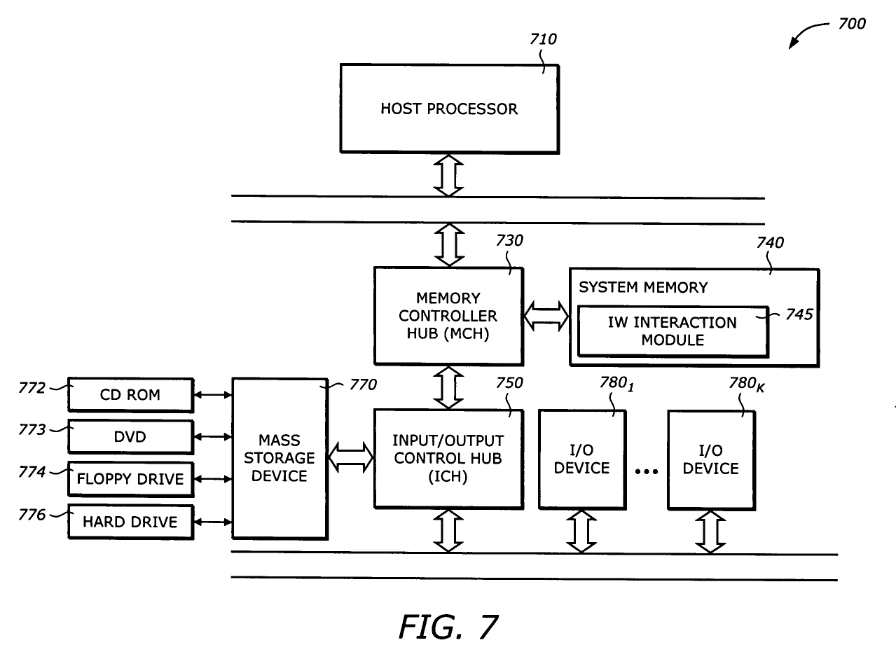

FIG. 7 is a diagram illustrating a computer system 700 according to one embodiment of the invention. The system 700 includes a host processor 710, a memory control hub (MCH) 730, a system memory 740, an input/output control hub (ICH) 750, a mass storage device 770, and input/output devices 780₁ to 780_{K}. Note that the system 700 may include more or less elements than these elements.

The host processor 710 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MCH 730 provides control and configuration of memory and input/output devices such as the system memory 740 and the ICH 750. The MCH 730 may be integrated into a chipset that integrates multiple functionalities such as the isolated execution mode, host-to-peripheral bus interface, memory control.

The system memory 740 stores system code and data. The system memory 740 is typically implemented with dynamic random access memory (DRAM) or static random access memory (SRAM). The system memory may include program code or code segments implementing one embodiment of the invention. The system memory includes an IW interaction module 745. Any one of the elements of the media delivery module may be implemented by hardware, software, firmware, microcode, or any combination thereof. The IW interaction module 745 may include the frame module, the information module, and the communication module as discussed above. The system memory 1240 may also include other programs or data which are not shown, such as an operating system.

The ICH 750 has a number of functionalities that are designed to support I/O functions. The ICH 750 may also be integrated into a chipset together or separate from the MCH 130 to perform I/O functions.

The mass storage device 770 stores archive information such as code, programs, files, data, applications, and operating systems. The mass storage device 770 may include compact disk (CD) ROM 772, a digital video/versatile disc (DVD) 773, floppy drive 774, and hard drive 776, and any other magnetic or optic storage devices. The mass storage device 770 provides a mechanism to read machine-accessible media. The machine-accessible media may contain computer readable program code to perform tasks as described above.

The I/O devices 780₁ to 780_{K} may include any I/O devices to perform I/O functions. Examples of I/O devices 780₁ to 780_{K} include controller for input devices (e.g., keyboard, mouse, trackball, pointing device), media card (e.g., audio, video, graphics), network card, and any other peripheral controllers.

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc that is implemented or embodied in a hardware structure (e.g., flash memory, ROM, EROM). Examples of firmware may include microcode, writable control store, microprogrammed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described above. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

As discussed above in the communication module, experiments should be conducted to evaluate how WiFi networks interfere with each other under various conditions. The experiments show how IW nodes are selected, how communication performance within a WiFi network are evaluated, how IW nodes determine the relative location of the other WiFi networks nearby, and finally how the overall WiFi usage in the area is determined. There are a number of experiments that can be conducted. These include experiments on interference and network performance, node network partitioning.

Experiments on Interference and Network Performance: The experiments on interference and network performance include experiments to determine the relationship between the interference and channel distance, the interference and the geographical distance, the interference and IW communication, and noise and channel usage.

Experiments on the interference and channel distance aim at determining how WiFi networks interfere depending on the channel they are using. A scenario may include two WiFi networks each with 2 clients, at a fixed location, and collecting information on noise level, maximum bandwidth, and dropped frames, depending on the channel difference between these two networks. Experiments should be performed at different rates (for example 1, 2, 5 and 11 Mbps) and also involve 3 WiFi networks each with 2 clients.

Experiments on the interference and geographic distance aim at determining how the physical distance between WiFi networks influence how networks interfere with each other. A scenario may include two WiFi networks each with two clients, collecting information on noise level, maximum bandwidth, and number of dropped frames, depending on the distance between these two networks (for example 1 m, 5 m, and 20 m). Distance between the clients of the same WiFi network should be varied (e.g., 1 m, 5 m, and 20 m). Such tests are preferably combined with the previous test on channel distance.

Experiments on interference and IW communication are intended (1) to evaluate how the propagation of IW frames between IW nodes interfere with traditional WiFi communication (i.e., between clients of a WiFi network), and (2) to evaluate the acceptable level of IW communication depending on the density of WiFi networks, the number of clients in the WiFi networks, and the maximum propagation count.

Experiments on noise and channel usage are intended to correlate the noise/interference experienced by a client and the activity on the client's channel. The results of this experiment are used by IW node to estimate channel usage. In this experiment, two clients of a WiFi network (WiFi 1) communicate and record the level of noise they experience while another two clients on a different WiFi network (WiFi 2) also communicate. The experiment is conducted at different data rates for both WiFi 1 and WiFi 2. From this experiment, three discrete levels of channel usage may be defined: free/under-used, used, and over-used. These levels will be used by IW node to decide if a WiFi network should switch to another channel, and to which channel it should switch.

IW Node WiFi Network Partitioning: One of the first issues that needs to be resolved in IW management is to decide which clients in a WiFi network should act as IW nodes. If two clients cover the same area, only one IW node is necessary. However, if these two clients are far apart and cover different physical areas (i.e., they interfere with different sets of WiFi networks), IW communication may improve from both being IW nodes.

Another parameter to take into account when deciding to have multiple IW nodes in a WiFi network is the cost related to synchronizing these IW nodes, and the interference created by them.

A first method to determine if two clients cover different areas relies on evaluating the signal strength between these two clients. If the signal is strong, clients are close and therefore cover the same area. A weak signal means distant clients. This method is however not precise due to the relative inaccuracy and high variability of the signal strength. Furthermore, there are cases that only the signal strength of the WiFi network's beacon can be obtained. Clients therefore only know about the signal strength with the beacon's sender. They, however, cannot determine if they are close to each other or not.

Another method compares the lists of beacons of WiFi networks received by each client. If two clients have the same list, it is reasonable to assume that they cover the same area and therefore only one IW node is necessary. If one list encompasses the other, only one IW node is needed. However, if the lists only slightly overlap, then each client may be should act as an IW node. The main drawback of this method is that scanning the different channels for collecting the beacons of the nearby WiFi networks is time consuming and blocks the radio for a short period of time in order to scan all channels (which greatly affects normal data communication).

In one embodiment, it is possible with the hostap driver under Linux to passively collect the beacons of the WiFi networks nearby (i.e., without blocking the radio in order to scan all channels), as long as these WiFi networks are on channels of overlapping frequencies. This is key feature that is exploited in IW communications as it allows injecting and receiving 802.11 frames from any WiFi network. Such list can indeed be used to determine if two clients cover the same area.

The first set of experiments aims to determine how much two lists of WiFi beacons should overlap to decide that the two clients cover the same area. It is also useful to evaluate if the signal strength associated to these beacons can be used to evaluate the area covered by the two clients.

Each client of a WiFi network incorporates a network information module. This module collects WiFi status information from the WiFi driver/subsystem. All clients exchange their network status information and beacon lists using standard UDP/TCP communication, either unicast or multicast.

Intra-WiFi Network Performance:—Prior to evaluating the usage of the different channels in its area, an IW node first evaluates how the different clients in its WiFi network are communicating, and how much bandwidth is available for them.

Several network monitoring tools exist that monitors the maximum bandwidth available on a communication link. For example, with Netperf, it can determine the TCP and UDP throughput between two hosts as well as the number of messages per seconds that can be exchanged. One issue with 802.11 performance is that the interference level, and therefore the maximum throughput available, depends on the time and location of the clients, even within the same WiFi network. In some cases, two sets of two clients from the same WiFi network may experience different throughput at the exact same time. A first series of tests is therefore required to determine how such tools can be used to effectively evaluate a WiFi network's maximum throughput.

In order to determine how the clients of a WiFi network are communicating, the received and sent data frame counters may be used. Such values, available in the hostap driver under Linux, provide the numbers of 802.11 data frames sent by a client, as well as the number of 802.11 data frames received by the client that were accepted (i.e., that had the proper header, and were encoded with the proper key). Ideally, the sum of the numbers of data frames sent by all the clients should be equal to the number of data frames received by each client. However, interference or distance may introduce discrepancies. For example, a data frame sent by a client may not be received by all other clients. Another series of tests is therefore required to determine how these counters can be used to evaluate the communication needs of a WiFi network.

These counters may also be used in order to determine if only one or a few clients are subject to interference (not all data frames are being received) or if all clients are being affected.

WiFi Network Location: IW nodes from different WiFi networks exchange IW network status information to evaluate the overall WiFi channel usage. From this usage information, IW nodes may then decide to switch their own WiFi network to another channel in order to improve communication performance. However, IW nodes first need to determine the location of the various WiFi networks it received IW network status information from. By using the location and the network status information, IW nodes can determine the channels usage at its location and in its vicinity. IW nodes are then able to predict how a channel change will affect its own performance as well as the performance of the other WiFi networks.

To determine the location of the different WiFi networks in a large area, IW nodes can rely on the beacon and signal strength lists. As discussed above, the clients of a WiFi network exchange these lists using standard IP communication in order to determine which clients should act as IW nodes. A similar approach may be used to determine the relative location of the WiFi networks by analyzing how they interfere. However, IW nodes on different WiFi networks exchange these lists using IW frames (e.g., special 802.11 frames).

The IW nodes in a WiFi network collect beacon and signal strength information in order to propagate it to other WiFi networks nearby using IW communication. After it collects these beacon and signal strength lists from the nearby WiFi networks, an IW node can determine how the WiFi networks overlap by comparing the beacon lists, and can therefore determine the relative location of the different WiFi networks. A simple location algorithm and simulation experiments to evaluate it may be used.

Channel Evaluation: Once an IW node has determined the relative location of the different WiFi networks nearby (in propagation range), it can build a map of the area that represents the channels usage based on the network status information provided by the IW nodes of these WiFi networks.

The first approach is for IW nodes to provide the communication needs of their WiFi network and the noise level they experience. From the collected information, active IW nodes then determine the channels usage in its surroundings. The second approach is for each active IW node to determine the channels usage at its location (radio range). The active IW node forwards this evaluation to IW nodes of the other networks. Active IW nodes build the channels usage map by associating the relative location of the WiFi networks and their estimation of the channels usage at their location.

In the first case, each active IW node individually evaluates the channels usage at its location. As active IW nodes are not synchronized, they may evaluate the channels usage based on different versions of IW information, leading to discrepancies. In the first approach, computation time is proportional to the number of WiFi networks in the propagation area while in the second approach, this computation time is fixed (only one evaluation is performed). Using the second method increases the interference created by IW communication as the information on channels usage also needs to be also propagated. However, as this information will be much condensed information, the extra interference is not significant and the second approach is therefore preferred.

In order to evaluate the channel usage at its location, an active IW node first determines which WiFi networks geographically overlap with its WiFi network as discussed above. It then collects the IW network status information from these networks. One major problem is to take into account the WiFi networks that do not support IW communication and therefore do not provide IW network status information. WiFi networks that do not support IW communication can be detected because they are periodically sending a beacon, but their communication needs are unknown.

If all WiFi networks at a location support IW communication, the IW node can determine the channel usage from the IW network status information exchanged by the IW nodes. If the other WiFi networks do not support IW communication, the channel usage is determined by the noise experienced by the IW node as discussed above.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. An apparatus comprising:
a frame module to process a frame containing information regarding a local node in a first network, the information including discovery information and network state information, the discovery information being represented in a common description;
an information module coupled to the frame module to manage the information; and
a communication module coupled to the frame module and the information module to manage communication between the local node and a remote node in a second network using the information.

2. The apparatus of claim 1 wherein the frame module comprises:
a frame builder to build the frame containing the information;
a frame transmitter coupled to the frame builder to transmit the frame to another local node in the first network or the remote node in the second network;
a frame poller coupled to the frame transmitter to provide a polling frame requesting for information of the remote node; and
a frame receiver to receive another frame from another local node in the first network or to receive a remote frame from the remote node.

3. The apparatus of claim 2 wherein the frame receiver forwards the received remote frame to the communication module if the received remote frame is related to the network communication.

4. The apparatus of claim 2 wherein the frame receiver forwards the received remote frame to the information module of the local node, to another local node in the first network, or to another remote node if the received remote frame is related to information exchange and meets an acceptance condition.

5. The apparatus of claim 4 wherein the acceptance condition is based on a forwarding number and propagation parameters including a propagation list and a propagation type, the forwarding number and the propagation type being contained in the frame.

6. The apparatus of claim 1 wherein the information module comprises:
a collector to collect the information;
a translator coupled to the collector to translate the discovery information into the common description;
a node selector coupled to the collector to determine if the local node participates in the communication based on the network state information of the local node and other network state information from another local node in the first network; and
a synchronizer to synchronize the collected information with other information. from other local nodes in the first network.

7. The apparatus of claim 6 wherein the information module further comprises:
an information table to store entries regarding information extracted from a received remote frame; and
an information table updater to update the entries.

8. The apparatus of claim 1 wherein the communication module comprises:
a usage evaluator to evaluate network usage to determine relative location of the second network based on an interference list from the network state information;
a channel migration evaluator to evaluate a channel allocation layout;
a channel change controller to control a channel change based in the channel allocation layout; and
a channel changer to change channel of the local node according to a wireless mode used by the node.

9. The apparatus of claim 8 wherein the channel migration evaluator evaluates an alternate layout based on a relationship between interference and channel distance.

10. The apparatus of claim 1 wherein the discovery information includes information on at least node device, node service, and user.

11. The apparatus of claim 1 wherein the network state information includes at least one of network configuration, network status, network history, and an interference list.

12. The apparatus of claim 11 wherein the interference list includes at least a network from which the local node receives a beacon or directly receives a remote frame from the remote node.

13. A method comprising:
processing a frame containing information regarding a local node in a first network, the information including discovery information and network state information, the discovery information being represented in a common description;
managing the information; and
managing communication between the local node and a remote node in a second network using the information.

14. The method of claim 13 wherein processing the frame comprises:
building the frame containing the information;
transmitting the frame to another local node in the first network or the remote node in the second network;
providing a polling frame requesting for information of the remote node; and
receiving another frame from another local node in the first network or a remote frame from the remote node.

15. The method of claim 14 wherein receiving comprises forwarding the received remote frame to the communication module if the received remote frame is related to the network communication.

16. The method of claim 14 wherein receiving comprises forwarding the received remote frame to the information module of the local node, to another local node in the first network, or to another remote node if the received remote frame is related to information exchange and meets an acceptance condition.

17. The method of claim 16 wherein the acceptance condition is based on a forwarding number and propagation parameters including a propagation list and a propagation type, the forwarding number and the propagation type being contained in the frame.

18. The method of claim 13 wherein managing the information comprises:
collecting the information;
translating the discovery information into the common description;
determining if the local node participates in the communication based on the network state information of the local node and other network state information from another local node in the first network; and
synchronizing the collected information with other information. from other local nodes in the first network.

19. The method of claim 18 wherein managing the information further comprises:
storing entries regarding information extracted from a received remote frame; and
updating the entries.

20. The method of claim 13 wherein managing the communication comprises:
evaluating network usage to determine relative location of the second network based on an interference list from the network state information;
evaluating a channel allocation layout;
controlling a channel change based in the channel allocation layout; and
changing channel of the local node according to a wireless mode used by the node.

21. The method of claim 20 wherein evaluating a channel allocation layout comprises evaluating an alternate layout based on a relationship between interference and channel distance.

22. The method of claim 13 wherein the discovery information includes information on at least node device, node service, and user.

23. The method of claim 13 wherein the network state information includes at least one of network configuration, network status, network history, and an interference list.

24. The method of claim 23 wherein the interference list includes at least a network from which the local node receives a beacon or directly receives a remote frame from the remote node.

25. An article of manufacture comprising:
a machine-accessible medium including data that, when accessed by a machine, causes the machine to perform operations comprising:
processing a frame containing information regarding a local node in a first network, the information including discovery information and network state information, the discovery information being represented in a common description;
managing the information; and
managing communication between the local node and a remote node in a second network using the information.

26. The article of manufacture of claim 25 wherein the data causing the machine to perform processing the frame comprises data that, when accessed by the machine, causes the machine to perform operations comprising:
building the frame containing the information;
transmitting the frame to another local node in the first network or the remote node in the second network;
providing a polling frame requesting for information of the remote node; and
receiving another frame from another local node in the first network or a remote frame from the remote node.

27. The article of manufacture of claim 26 wherein the data causing the machine to perform receiving comprises data that, when accessed by the machine, causes the machine to perform operations comprising forwarding the received remote frame to the communication module if the received remote frame is related to the network communication.

28. The article of manufacture of claim 26 wherein the data causing the machine to perform receiving comprises data that, when accessed by the machine, causes the machine to perform operations comprising forwarding the received remote frame to the information module of the local node, to another local node in the first network, or to another remote node if the received remote frame is related to information exchange and meets an acceptance condition.

29. The article of manufacture of claim 28 wherein the acceptance condition is based on a forwarding number and propagation parameters including a propagation list and a propagation type, the forwarding number and the propagation type being contained in the frame.

30. The article of manufacture of claim 25 wherein the data causing the machine to perform managing the information comprises data that, when accessed by the machine, causes the machine to perform operations comprising:
collecting the information;
translating the discovery information into the common description;
determining if the local node participates in the communication based on the network state information of the local node and other network state information from another local node in the first network; and
synchronizing the collected information with other information. from other local nodes in the first network.

31. The article of manufacture of claim 30 wherein the data causing the machine to perform managing the information further comprises data that, when accessed by the machine, causes the machine to perform operations comprising:
storing entries regarding information extracted from a received remote frame; and
updating the entries.

32. The article of manufacture of claim 25 wherein the data causing the machine to perform managing the communication comprises data that, when accessed by the machine, causes the machine to perform operations comprising:
evaluating network usage to determine relative location of the second network based on an interference list from the network state information;
evaluating a channel allocation layout;
controlling a channel change based in the channel allocation layout; and
changing channel of the local node according to a wireless mode used by the node.

33. The article of manufacture of claim 32 wherein the data causing the machine to perform evaluating a channel allocation layout comprises data that, when accessed by the machine, causes the machine to perform operations comprising evaluating an alternate layout based on a relationship between interference and channel distance.

34. The article of manufacture of claim 25 wherein the discovery information includes information on at least node device, node service, and user.

35. The article of manufacture of claim 25 wherein the network state information includes at least one of network configuration, network status, network history, and an interference list.

36. The article of manufacture of claim 35 wherein the interference list includes at least a network from which the local node receives a beacon or directly receives a remote frame from the remote node.

37. An apparatus comprising:
means for processing a frame containing information regarding a local node in a first network, the information including discovery information and network state information, the discovery information being represented in a common description;
means for managing the information; and
means for managing communication between the local node and a remote node in a second network using the information.

38. The apparatus of claim 37 wherein the means for processing the frame comprises:
means for building the frame containing the information;
means for transmitting the frame to another local node in the first network or the remote node in the second network;
means for providing a polling frame requesting for information of the remote node; and
means for receiving another frame from another local node in the first network or a remote frame from the remote node.

39. The apparatus of claim 37 wherein the means for managing the information comprises:
means for collecting the information;
means for translating the discovery information into the common description;
means for determining if the local node participates in the communication based on the network state information of the local node and other network state information from another local node in the first network; and
means for synchronizing the collected information with other information. from other local nodes in the first network.

40. The apparatus of claim 37 wherein the means for managing the communication comprises:
means for evaluating network usage to determine relative location of the second network based on an interference list from the network state information;
means for evaluating a channel allocation layout;
means for controlling a channel change based in the channel allocation layout; and
means for changing channel of the local node according to a wireless mode used by the node.
